(19) United States
(12) Patent Application Publication
(10) Pub. No.: US 2024/0154990 A1
(43) Pub. Date: May 9, 2024

(54) DEVICE FOR AUTOMATICALLY SORTING CYBER ATTACK BASED ON ARTIFICIAL INTELLIGENCE USING SECURITY EVENT OF DIFFERENT KINDS OF SECURITY DEVICES

(71) Applicant: Korea Internet & Security Agency, Naju-si (KR)

(72) Inventors: Do Won KIM, Naju-si (KR); Tae Eun KIM, Naju-si (KR); Ki Jong SON, Naju-si (KR); Sae Woom LEE, Naju-si (KR); Seul Ki CHOI, Naju-si (KR); Tae Hyeon KIM, Naju-si (KR); Gyeong Jin NA, Naju-si (KR)

(73) Assignee: Korea Internet & Security Agency, Naju-si (KR)

(21) Appl. No.: 18/385,384

(22) Filed: Oct. 31, 2023

(30) Foreign Application Priority Data
Nov. 9, 2022 (KR) 10-2022-0148492

(51) Int. Cl. H04L 9/40

(52) U.S. Cl. CPC H04L 63/1433; H04L 63/1416; H04L 63/1425

(57) ABSTRACT

A device for automatically sorting a cyber attack includes an event feature generator that extracts a unique attacker IP by analyzing attacker IPs for each of the different kinds of security devices, and generates AI learning features of the security events of the different kinds of security devices including feature numerical data quantifying at least two or more features through attack information analysis recorded in the different kinds of security devices based on the information on the security events of the different kinds of security devices mapped to the extracted unique attacker IP, and an attack type sorter that learns the generated feature numerical data using an unsupervised learning algorithm, generates clustering data by sorting the feature numerical data into similar attack data and clustering sorted feature numerical data, and then analyzes the generated clustering data to identify a short-term or long-term attacker's cyber attack type.

### BACKGROUND

### 1. Field of the Invention

The present invention relates to a device for automatically sorting a cyber attack, and more particularly, to a device for automatically sorting a cyber attack by learning attack feature information of security events of different kinds of security devices, such as a firewall and an intrusion detection system, through artificial intelligence.

### 2. Discussion of Related Art

Centers and companies that control cyber attacks are equipped with various different kinds of security devices, but security analysis often needs to be individually performed on each of the different kinds of security devices.

That is, artificial intelligence-based detection technology that uses event data from a single security device analyzes only limited information of a single event to determine whether it is normal or a cyber attack.

To solve this problem, Korean Patent Laid-Open Publication No. 2018-0044658 discloses a high level detector for an event between different kinds of security devices that includes an event collection module collecting event logs detected by different kinds of security devices, a categorization management module analyzing the detection event logs collected in the event collection module, categorizing and managing the analyzed detection event logs according to attack types for each area, and setting and managing policies for multiple categories for each area, and a handler module managing different kinds of security devices and areas and providing area information and information on different kinds of security devices to the categorization management module.

However, such a conventional high level detector for an event between different kinds of security devices detects and analyzes security events of various different kinds of security devices, so there is a problem in that it takes a long time to analyze.

In addition, the high level detector for an event between different kinds of security devices described above is detecting cyber attacks depending on association analysis rules of security events of different kinds of security devices predefined by humans, and has a problem in that the rule-based attack detection may detect only defined patterns to make it difficult to detect similar attacks or new attacks.

In particular, recently, as the tendency to conduct long-term cyber attacks rather than a one-shot cyber attack has been increasing, identifying and detecting attackers who perform the long-term attacks are emerging as important tasks. The high level detector for an event between different kinds of security devices described above has a problem in that it takes a long time to detect only a short-term or one-shot cyber attack even if security events of various different kinds of security devices are detected.

### RELATED ART DOCUMENT

### Patent Document

(Patent Document 1) Korean Patent Laid-Open Publication No. 2018-0044658 (Published Date: May 3, 2018): High Level Detector for Event between Different Kinds of Security Devices

### SUMMARY OF THE INVENTION

The present invention provides a device for automatically sorting a cyber attack based on artificial intelligence for detecting the cyber attack by automatically analyzing a security event occurring over a long term period of time in different kinds of security devices through an artificial intelligence algorithm.

According to an exemplary embodiment, a device for automatically sorting a cyber attack based on artificial intelligence includes: a data set normalizer that collects security threat data from each of at least two different kinds of security devices, and normalizes event fields and formats of the collected security threat data into standardized events of the different kinds of security devices; a data set sorter that sorts a data set by grouping the events of the different kinds of security devices of a normalized data set based on a confirmed attacker Internet protocol (IP); an event feature generator that extracts a unique attacker IP by analyzing attacker IPs for each of the different kinds of security devices included in sorted information on the security events of the different kinds of security devices, and generates AI learning features of the security events of the different kinds of security devices including feature numerical data quantifying at least two or more features through attack information analysis recorded in the different kinds of security devices based on the information on the security events of the different kinds of security devices mapped to the extracted unique attacker IP; and an attack type sorter that learns the generated feature numerical data using an unsupervised learning algorithm, generates clustering data by sorting the feature numerical data into similar attack data and clustering sorted feature numerical data, and then analyzes the generated clustering data to identify a short-term or long-term attacker's cyber attack type (the cyber attack type includes initial access, simple scanning, an advanced persistent threat (APT) attack, and other abnormal activities) to generate an attack type label.

The security device may include enterprise security management (ESM), security information & event management (SIEM), an intrusion detection system (IDS), and a machine learning solution.

The data set normalizer may include: a heterogeneous file format normalization unit that converts all of the collected events of the different kinds of security devices into a common format including JavaScript object notation (JSON) and structured threat information expression (STIX); a data normalization unit that normalizes a security event field name and data (time, IP, etc.) format in the converted event field and format; and a comma-separated values (CSV) conversion unit that selects learning target security events of the different kinds of security devices from among normalized security events of the different kinds of security devices and converts the selected learning target security events into a CSV format.

The event feature generator may analyze the attacker IP to extract the unique attacker IP when the number of different kinds of security devices included in the normalized and sorted information on the security events of the different kinds of security devices is two or more, and may be terminated when the number of different kinds of security devices is two or less.

The event feature generator may perform attack information analysis on the different kinds of security devices as long as a length of an IP list having the extracted unique attacker IP, and generate the AI learning features of the security events of the different the kinds of security devices to be used in artificial intelligence learning when the attack information analysis is completed.

The feature numerical data may include a attack period, the total number of attacks, the number of detected security devices, the number of firewall blocks, the number of detected attack types, the number of attack methods, the number of scans, the number of attack target assets, the number of attack target ports, the number of abnormal time detections, the number of end point attack detections, the number of detections for each risk level, and the number of web attack detections.

The performance of the attack information analysis on the different kinds of security devices may include identifying an attack period, whether the attack is executed, an attack range, whether to execute the attack, an attack range, whether there is a harmful/malicious IP, and an attack type.

The attack type sorter may include: a feature scaling unit that generates feature scaling information by performing a scaling function to adjust a value range of the feature numerical data to a preset level range; a feature dimension reduction unit that generates feature dimension reduction information by dimension-reducing the feature scaling information to the specific number of dimensions when dimension reduction is required for the generated feature scaling information; an artificial intelligence clustering unit that generates the clustering data by performing the unsupervised learning algorithm receiving the generated feature dimension reduction information; and an attack type label unit that analyzes the generated clustering data and generates the attack type label that labels similar attack IP bundles for each attack type.

The feature dimension reduction unit may use open principal component analysis (PCA) and uniform manifold approximation and projection (UMAP) algorithms, and the unsupervised learning algorithm may use a clustering machine learning library including open hierarchical density-based spatial clustering of applications with noise (HDBSCAN) and K-Means.

When the dimension reduction is not required by the feature dimension reduction unit, the artificial intelligence clustering unit may generate the clustering data by performing the unsupervised learning algorithm using the clustering machine learning library of the HDBSCAN receiving the feature scaling information.

### BRIEF DESCRIPTION OF THE DRAWINGS

FIG. 1 is a schematic configuration diagram of a system for sorting a cyber attack according to an embodiment of the present invention.

FIG. 2 is a detailed configuration diagram of a device for sorting a cyber attack according to an embodiment of the present invention.

FIG. 3 is a diagram illustrating a grouping result realized by a data normalizer disclosed in the device for sorting a cyber attack of FIG. 2.

FIG. 4 is a diagram illustrating a unique attacker Internet protocol (IP) extraction process realized by an event feature generator disclosed in the device for sorting a cyber attack of FIG. 2.

FIG. 5 is a diagram illustrating a process of generating features of security events of different kinds of security devices through the attack analysis using the unique attacker IP extracted in FIG. 4.

FIG. 6 is a diagram summarizing at least one feature of the security events of different kinds of security devices generated by FIG. 5 in a table form.

FIG. 7 is a configuration diagram illustrating an attack type sorter according to an embodiment of the present invention.

FIG. 8 is a flowchart illustrating a process of processing the attack type sorter of FIG. 7.

### DETAILED DESCRIPTION OF EXEMPLARY EMBODIMENTS

Embodiments to be described in this specification and configurations illustrated in the accompanying drawings are only preferred examples of the disclosed invention, and at the time of filing the present application, there may be various modifications that can replace the embodiments and drawings in the present specification.

Terms used in the specification are used to describe embodiments, and are not intended to restrict and/or limit the disclosed invention. For example, in the present specification, singular forms may include plural forms unless the context clearly indicates otherwise. In particular, in the following, each terminal is expressed as a singular number, but it should be understood to mean a plural number in practice.

In addition, terms such as “include” and the like are intended to express the presence of features, numbers, steps, operations, components, parts, or combinations thereof described in the specification, and the possibility of additional presence or addition of one or more other features, numbers, steps, operations, components, parts or combinations thereof is not excluded.

In addition, terms including an ordinal number, such as “first” or the like, are used to distinguish one component from other components and do not refer to the one component.

In addition, the term “unit” may refer to a unit that processes at least one function or operation. For example, the term “unit” may refer to at least one piece of hardware such as field-programmable gate array (FPGA)/application specific integrated circuit (ASIC), at least one piece of software stored in a memory, or at least one process processed by a processor.

Hereinafter, embodiments of the disclosed invention will be described in detail with reference to each of the accompanying drawings.

FIG. 1 is a schematic configuration diagram of a system for sorting a cyber attack according to an embodiment of the present invention.

Referring to FIG. 1, the system for sorting a cyber attack according to the embodiment of the present invention includes at least one security device 100 and a device 200 for sorting a cyber attack for real-time security management of at least two security devices connected through a network in a narrow or broad sense.

The above-described network refers to a connection structure in which information can be exchanged between each node connected to the at least one security device 100 and the device 200 for sorting a cyber attack. Examples of such networks may include a local area network (LAN) and a wired data communication network in a narrow sense, and a wide area network (WAN), an Internet network (World Wide Web (WWW)), a wireless broadband (WiBro) network, and a mobile communication network in a broad sense, but are not necessarily limited thereto. For example, the above-described narrow network in a narrow sense may be an in-house wired network.

In an embodiment, the at least one security device 100 may include enterprise security management (ESM), security information & event management (SIEM), an intrusion detection system (IDS), and a machine learning solution, but is not limited thereto.

Here, the ESM is an integrated security management system that gathers logs and events from security solutions such as a firewall, an intrusion prevention system (IPS) (intrusion detection system (IDS)), and unified threat management (UTM), and may perform functions such as integrated management of integrated solutions and interconnection between solutions, the SIEM is a system in which security information management (SIM) and security event management (SEM) are combined and has an evolved form of enterprise security management (ESM), and may refer to an integrated security control solution that collects logs and events occurring in a wide range such as various types of server equipment, network equipment, and application programs installed on a computer, and blocks threats in advance through big data-based correlation analysis.

However, the security device 100 may generate security threat data including different logs and events.

In an embodiment, the device 200 for sorting a cyber attack may collect security threat data including different logs and events generated from different kinds of security devices 100 connected to an arbitrary network, and sort the security threat data into a data set of standardized events of different kinds of security devices.

Furthermore, the device 200 for sorting a cyber attack may extract a unique attacker Internet protocol (IP) by analyzing the attacker IPs for each of the different kinds of security devices included in the sorted security event information of different kinds of security devices, and generates AI learning features of the security events of different kinds of security devices including numerical data quantifying at least two or more features through attack information analysis recorded in different kinds of security devices based on the security event information of different kinds of security devices mapped to the extracted unique attacker IP.

In addition, the device 200 for sorting a cyber attack may learn the generated feature numerical data using an unsupervised learning algorithm, generate clustering data sorting the feature numerical data into similar attack data and clustering the sorted feature numerical data, and then analyze the generated clustering data to identify a short-term or long-term attacker's cyber attack type (the cyber attack type include initial access, simple scanning, an advanced persistent threat (APT) attack, and other abnormal activities) to generate an attack type label.

Hereinafter, the device 200 for sorting a cyber attack described above will be described in more detail.

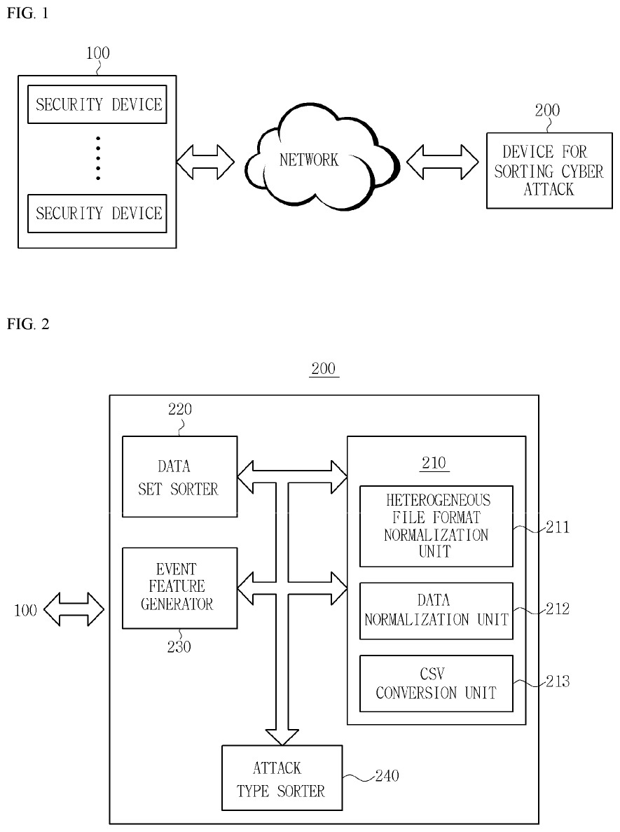

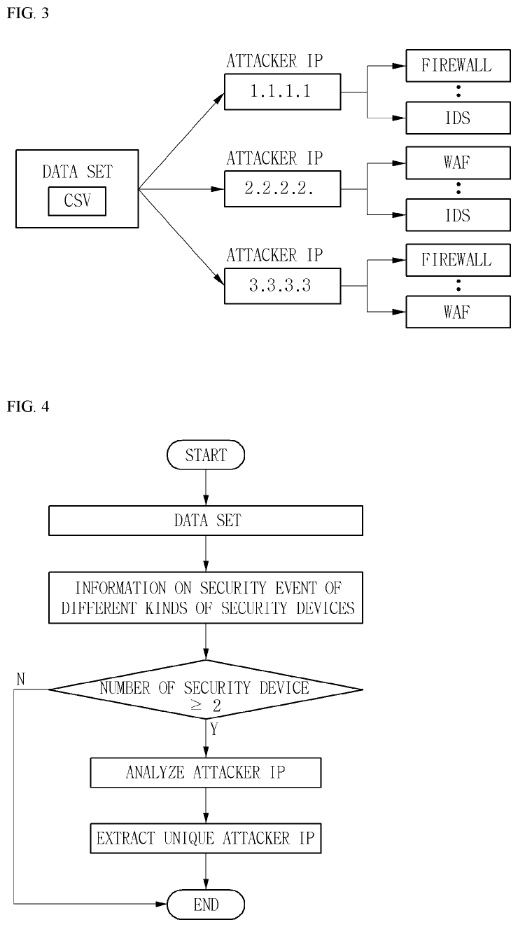

FIG. 2 is a detailed configuration diagram of a device for sorting a cyber attack according to an embodiment of the present invention and FIG. 3 is a diagram illustrating a grouping result realized by a data normalizer disclosed in the device for sorting a cyber attack of FIG. 2.

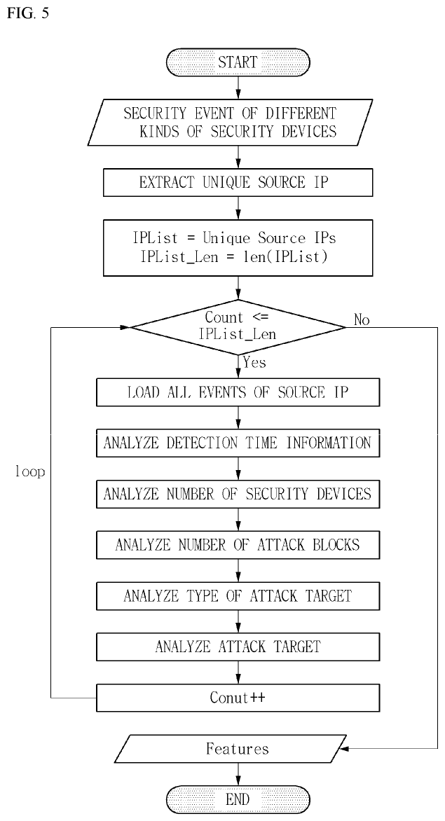

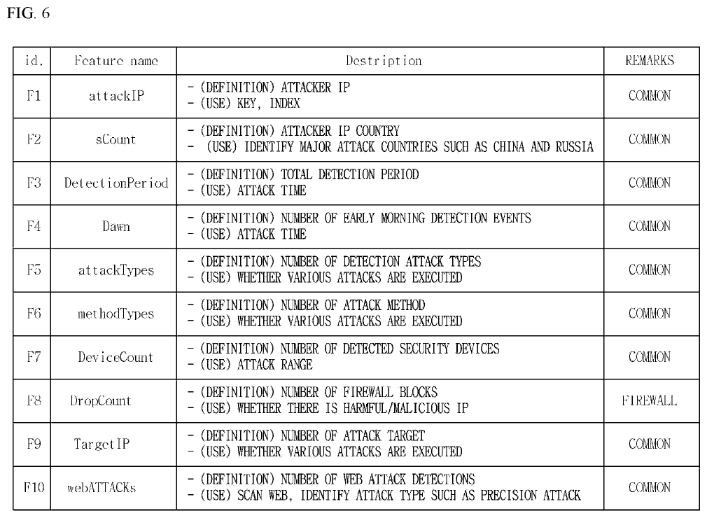

FIG. 4 is a diagram illustrating a unique attacker IP extraction process realized by an event feature generator disclosed in the device for sorting a cyber attack of FIG. 2, FIG. 5 is a diagram illustrating a process of generating features of the security events of different kinds of security devices through the attack analysis using the unique attacker IP extracted in FIG. 4, and FIG. 6 is a diagram summarizing at least one feature of the security events of different kinds of security devices generated by FIG. in a table form.

FIGS. 3 to 6 will be cited as auxiliary when describing FIG. 2.

Referring to FIG. 2, the device 200 for sorting a cyber attack according to the embodiment includes a data set normalizer 210, a data set sorter 220, an event feature generator 230, and an attack type sorter 240.

In an embodiment, the data set normalizer 210 may collect security threat data from each of at least two different kinds of security devices 100. The collected security threat data may have different raw data file formats, for example, non-unified file data such as TXT, XLS, and TSV files.

Accordingly, the data set normalizer 210 needs to convert the security threat data including different file data into unified data, and may normalize, for example, event fields and formats of the security threat data into standardized events of different kinds of security devices.

To this end, the data set normalizer 210 may include a heterogeneous file format normalization unit 211 that converts all of the events of different kinds of security devices collected from at least two different kinds of security devices 100 into a common format including JavaScript object notation (JSON) and structured threat information expression (STIX), a data normalization unit 212 that normalizes a security event field name and data (time, IP, etc.) format in the converted event field and format, and a comma-separated values (CSV) conversion unit 213 that selects learning target security events of different kinds of security devices from among the normalized security events of different kinds of security devices and converts the selected learning target security events into a CSV format.

The above-described CSV format may be text data in which several fields are separated by comma (,). Since the security threat data collected from at least one security device 100 has different file formats, the CSV format is the result of conversion to unify the security threat data. The data set of the events of different kinds of security devices described above may also refer to standardized data by mapping the CSV format, which unifies the security threat data collected from different security devices 100, to different security devices 100.

Accordingly, the data set sorter 220 may sort the data set by grouping the events of different kinds of security devices in the normalized data set based on the confirmed attacker IP.

For example, as illustrated in FIG. 3, each piece of sorted information on the security events of different kinds of security devices may be sorted into a data set that includes the attacker IP (source IP) generated from each security device 100, the security devices (e.g., IDS, web application firewall (WAF), and firewall) mapped to each attacker IP, and various types of security threat events generated by the attacker IP.

In an embodiment, the event feature generator 230 may extract a unique attacker IP by analyzing attacker IPs for each of the different kinds of security devices sorted by the data set sorter 220 described above.

For example, as illustrated in FIG. 4, in order to detect a unique attacker IP address, the event feature generator 230 may analyze the attacker IP included in the information on the security events of each of different kinds of security devices to extract the unique attacker IP when the number of different kinds of security devices included in the normalized and sorted information on the security events of different kinds of security devices is two or more, and may terminate the attacker IP detection by considering to be normal when the number of different kinds of security devices included in the information on the security events of different kinds of security devices is two or less.

In addition, the event feature generator 230 may generate the AI learning features of the security events of different kinds of security devices including feature numerical data quantifying at least two or more features through attack information analysis recorded in different kinds of security devices based on the information on the security events of different kinds of security devices mapped to the extracted unique attacker IP.

Here, as illustrated in FIG. 6, the performance of the attack information analysis on different kinds of security devices described above may include identifying the attack period, whether to execute the attack, an attack range, whether there is a harmful/malicious IP, and an attack type, but is not limited thereto.

For example, as illustrated in FIG. 5, the event feature generator 230 may load all security events of different kinds of security devices of the attacker IP as long as a length of an IP list including the extracted unique attacker IP, and repeatedly perform the attack information analysis on different kinds of security devices based on all the loaded security events of different kinds of security devices. Although five pieces of attack information analysis illustrated in FIG. 5 is exemplified, approximately 10 pieces of attack information as long as the length of the IP list may be repeatedly performed as illustrated in FIG. 6.

In this way, when approximately 10 pieces of attack information analysis as long as the length of the IP list are repeatedly completed, the event feature generator 230 may generate at least one AI learning feature of the security events of different according to the analysis of approximately 10 pieces of attack information analysis to be used in the artificial intelligence learning.

In this case, at least one AI learning feature of the security events of different kinds of security devices may be used in the artificial intelligence learning, such as unsupervised learning, as described above, and as illustrated in FIG. 6, may include feature numerical data, which can identify the number of different types through performing the attack information analysis on different kinds of security devices, and identifications (IDs), feature names, and the like of the security events of different kinds of security devices mapped to the feature numerical data.

In this way, at least one AI learning feature of the security events of different kinds of security devices is the result of performing the attack information analysis on different kinds of security devices and is feature information to be used for the artificial intelligence learning. In FIG. 6, the IDs, feature names, descriptions, and the like of the security events of different kinds of security devices are briefly recorded.

For example, as illustrated in FIG. 6, when a total detection period analysis is performed based on all loaded security events of different kinds of security devices, the AI learning features of the security events of different kinds of feature data such as the attack period may be known, when the analysis of the number of detected security devices is executed, the AI learning features of the security events of different kinds of security devices of the feature numerical data such as the attack range may be known, and when the number of attack targets is analyzed based on all the loaded security events of different kinds of security devices, the AI learning features of the security events of different kinds of security devices of the feature numerical data, such as whether to execute various attacks, may be known.

In other words, for example, data required for approximately 10 pieces of attack information analysis mapped to the AI learning features of the security events of different kinds of security devices, for example, the feature numerical data such as the number of attack methods is mapped to F6 ID and a methodTypes feature name, so it is possible to confirm whether to execute various attacks using feature numerical data, and feature numerical data, such as the number of firewall blocks, is mapped to F8 ID and a DropCount feature name, so it is possible to confirm whether there is the harmful/malicious IP using the feature numerical data.

Specific examples of the above-described feature numerical data may include an attack period, the total number of attacks, the number of detected security devices, the number of firewall blocks, the number of detected attack types, the number of attack methods, the number of scans, the number of attack target assets, the number of attack target ports, the number of abnormal time detections, the number of end point attack detections, the number of detections for each risk level, and the number of web attack detections, but are not limited thereto.

Unlike text data, the feature numerical data may provide the advantage of not performing or minimizing separate complex preprocessing processes such as parsing and embedding.

In an embodiment, the attack type sorter 240 may learn the feature numerical data of the security events of different kinds of security devices generated by the event feature generator 230 using the artificial intelligence learning, for example, the unsupervised learning algorithm.

In this case, the value range of the feature numerical data is not constant, and therefore, should be scaled to a certain level of range. Once the scaling is completed, the feature numerical data may be reduced to the specific number of dimensions through a dimension reduction function and input to the unsupervised learning algorithm of the artificial intelligence described above, so the unsupervised learning algorithm may perform the artificial intelligence learning based on the feature numerical data.

In this case, the above-described unsupervised learning algorithm may be trained using a clustering machine learning library including the widely known open hierarchical density-based spatial clustering of applications with noise (HDBSCAN) and K-Means.

Therefore, the attack type sorter 240 may generate, as a result of leaning the generated feature numerical data using the clustering machine learning library of the unsupervised learning algorithm, clustering data by sorting the features of the security events of different kinds of security devices including the feature numerical data into similar attack data.

Furthermore, the attack type sorter 240 according to the embodiment may analyze the generated clustering data and generate an attack type label that labels similar attack IP bundles for each attack type in order to identify the attacker type.

The configuration of the attack type sorter 240 is as follows.

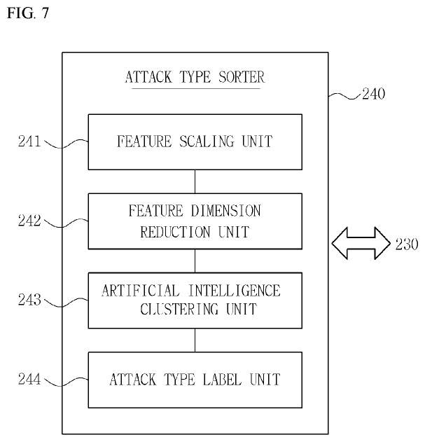

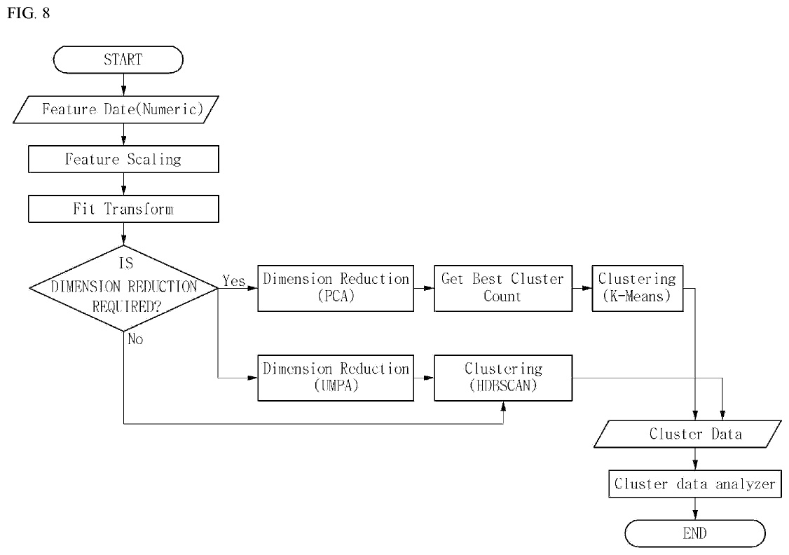

FIG. 7 is a configuration diagram illustrating the attack type sorter according to an embodiment of the present invention and FIG. 8 is a flowchart illustrating a process of processing the attack type sorter of FIG. 7.

As illustrated, the attack type sorter 240 according to the embodiment may include a feature scaling unit 241, a feature dimension reduction unit 242, an artificial intelligence clustering unit 243, and an attack type label unit 244.

In an embodiment, the feature scaling unit 241 may perform a scaling function of adjusting the value range of the feature numerical data received from the event feature generator 230 to a preset level range to generate feature scaling information. In this case, fit transform may be performed on the generated feature scaling information.

In an embodiment, when the dimension reduction is required for the feature scaling information on which the fit transform has been performed, the feature dimension reduction unit 242 may perform the dimension reduction function to dimension-reduce the feature scaling information to the specific number of dimensions, thereby generating the feature dimensional reduction information.

The dimension reduction function of the feature dimension reduction unit 242 may be an open principal component analysis (PCA) technique or a uniform manifold approximation and projection (UMAP) technique.

In an embodiment, the artificial intelligence clustering unit 243 may perform an unsupervised learning algorithm that receives dimension-reduced feature dimension reduction information. In this case, the above-described unsupervised learning algorithm may use the clustering machine learning library including the HDBSCAN and K-Means.

Therefore, when the artificial intelligence clustering unit 243 performs the unsupervised learning algorithm through the clustering machine learning library including the open HDBSCAN or/and K-Means, the artificial intelligence clustering unit 243 may generate the clustering data that bundles the dimension-reduced feature information with similar attacker IPs.

However, when the dimension reduction is not necessary due to the feature dimension reduction unit 242, the artificial intelligence clustering unit 243 may generate the clustering data through the unsupervised learning algorithm using the clustering machine learning library of the HDBSCAN that receives the feature scaling information.

Therefore, the attack type label unit 244 according to the embodiment may analyze the generated clustering data and generate an attack type label that labels similar attack IP bundles for each attack type in order to identify the attacker type.

Meanwhile, the data set normalizer 210, data set sorter 220, event feature generator 230, and attack type sorter 240 may be configured in one system described above, or may be configured in different systems.

For example, when the data set normalizer 210, data set sorter 220, event feature generator 230, and attack type sorter 240 are configured in one system, the data set normalizer 210, the data set sorter 220, the event feature generator 230, and the attack type sorter 240 may be configured by dividing the controller, and when configured in different systems, the data set normalizer 210, the data set sorter 220, the event feature generator 230, and the attack type sorter 240 may refer to each controller provided in different systems.

As such, the controller that can be configured in one system or multiple systems may include at least one processor, a memory, and a hardware module, and the at least one processor may include hardware configurations such as a micro processing unit (MPU) or a central processing unit (CPU), a cache memory, a data bus.

In this case, each configuration of the data set normalizer 210, the data set sorter 220, the event feature generator 230, and the attack type sorter 240 may be a hardware module or a software component module, which may be processed by at least one processor described above.

In addition, each functional operation performed by the data set normalizer 210, the data set sorter 220, the event feature generator 230, and the attack type sorter 240 may be implemented in the form of program instructions and recorded on a computer-readable recording medium.

The above-described computer-readable recording medium may include a combination or one of a program command, a data file, a data structure, and the like. The program commands recorded on the computer-readable recording medium may be especially designed and constituted for the present invention or be known to those skilled in a field of computer software. Examples of the computer-readable recording medium may include a magnetic medium such as a hard disk, a floppy disk, or a magnetic tape, an optical recording medium such as a compact disk read only memory (CD-ROM) or a digital versatile disk (DVD), a magneto-optical medium such as a floptical disk, and a hardware device specially configured to store and execute program commands, such as a read only memory (ROM), a random access memory (RAM), a flash memory, or the like. Examples of the program commands include a high-level language code to be executed by a computer using an interpreter, or the like, as well as a machine language code made by a compiler. The above-described hardware device may be constituted to be operated as one or more software modules to perform processing according to the present disclosure, and vice versa.

As described above, embodiments of the present invention aim to realize the following beneficial advantages due to each of the above-described solutions.

First, according to an embodiment of the present invention, since cyber attacks are automatically detected using artificial intelligence technology to identify attack features included in a large-capacity security events of different kinds of security devices, unlike the existing technology, it is possible to minimize human intervention, and since the detection does not depend on defined rules, it is possible to quickly detect similar or unknown cyber attacks.

Second, according to an embodiment of the present invention, by learning features of security events of different kinds of security devices collected over a specific long period of time using an artificial intelligence model to identify and sort long-term-based cyber attack types, it is possible to quickly detect attackers who pose a threat to assets or perform abnormal activities over a long period of time from a macroscopic perspective.

Third, according to an embodiment of the present invention, it is possible to cluster similar attack types by learning features of security events of different kinds of security devices based on an attacker Internet protocol (IP), it is possible to identify important cyber attack threats to corporate protection assets by analyzing clustered attack types, and it is possible for control personnel and security personnel to view the information and quickly utilize the information for response and action.

The present invention is not limited to the effects described above, and other effects that are not described may be clearly understood by those skilled in the art from the description below.

Meanwhile, although the present invention has been described by embodiments and drawings limited to specific details such as specific components according to the embodiments of the present invention described above, they have been provided only for assisting in the entire understanding of the present invention. Therefore, the present invention is not limited to the embodiments. Various modifications and changes may be made by those skilled in the art to which the present invention pertains from this description.

Therefore, the idea described in the present invention should not be limited to the embodiments described above. In addition, not only the scope of the patent claims described below, but also all modifications equal to or equivalent to the scope of this patent claim fall within the scope of the spirit of the present invention.

What is claimed is:

1. A device for automatically sorting a cyber attack based on artificial intelligence, comprising:
a data set normalizer that collects security threat data from each of at least two different kinds of security devices and normalizes event fields and formats of the collected security threat data into standardized events of the different kinds of security devices;
a data set sorter that sorts a data set by grouping the events of the different kinds of security devices of a normalized data set based on a confirmed attacker Internet protocol (IP);
an event feature generator that extracts a unique attacker IP by analyzing attacker IPs for each of the different kinds of security devices included in sorted information on the security events of the different kinds of security devices, and generates AI learning features of the security events of the different kinds of security devices including feature numerical data quantifying at least two or more features through attack information analysis recorded in the different kinds of security devices based on the information on the security events of the different kinds of security devices mapped to the extracted unique attacker IP; and
an attack type sorter that learns the generated feature numerical data using an unsupervised learning algorithm, generates clustering data by sorting the feature numerical data into similar attack data and clustering sorted feature numerical data, and then analyzes the generated clustering data to identify a short-term or long-term attacker's cyber attack type (the cyber attack type includes initial access, simple scanning, an advanced persistent threat (APT) attack, and other abnormal activities) to generate an attack type label.

2. The device of claim 1, wherein the security device includes enterprise security management (ESM), security information & event management (SIEM), an intrusion detection system (IDS), and a machine learning solution.

3. The device of claim 1, wherein the data set normalizer includes:
a heterogeneous file format normalization unit that converts all of the collected events of the different kinds of security devices into a common format including JavaScript object notation (JSON) and structured threat information expression (STIX);
a data normalization unit that normalizes a security event field name and data (time, IP, etc.) format in the converted event field and format; and
a comma-separated values (CSV) conversion unit that selects learning target security events of the different kinds of security devices from among normalized security events of the different kinds of security devices and converts the selected learning target security events into a CSV format.

4. The device of claim 1, wherein the event feature generator analyzes the attacker IP to extract the unique attacker IP when the number of different kinds of security devices included in the normalized and sorted information on the security events of the different kinds of security devices is two or more, and is terminated when the number of different kinds of security devices is two or less.

5. The device of claim 1, wherein the event feature generator performs attack information analysis on the different kinds of security devices as long as a length of an IP list having the extracted unique attacker IP, and when the attack information analysis is completed, generates the AI learning features of the security events of different the kinds of security devices to be used in artificial intelligence learning.

6. The device of claim 5, wherein the feature numerical data includes a attack period, the total number of attacks, the number of detected security devices, the number of firewall blocks, the number of detected attack types, the number of attack methods, the number of scans, the number of attack target assets, the number of attack target ports, the number of abnormal time detections, the number of end point attack detections, the number of detections for each risk level, and the number of web attack detections.

7. The device of claim 5, wherein the performance of the attack information analysis on the different kinds of security devices includes identifying an attack period, whether to execute the attack, an attack range, whether there is a harmful/malicious IP, and an attack type.

8. The device of claim 1, wherein the attack type sorter includes:
a feature scaling unit that generates feature scaling information by performing a scaling function to adjust a value range of the feature numerical data to a preset level range;
a feature dimension reduction unit that generates feature dimension reduction information by dimension-reducing the feature scaling information to the specific number of dimensions when dimension reduction is required for the generated feature scaling information;
an artificial intelligence clustering unit that generates the clustering data by performing the unsupervised learning algorithm receiving the generated feature dimension reduction information; and
an attack type label unit that analyzes the generated clustering data and generates the attack type label that labels similar attack IP bundles for each attack type.

9. The device of claim 8, wherein the feature dimension reduction unit uses open principal component analysis (PCA) and uniform manifold approximation and projection (UMAP) algorithms, and the unsupervised learning algorithm uses a clustering machine learning library including open hierarchical density-based spatial clustering of applications with noise (HDBSCAN) and K-Means.

10. The device of claim 9, wherein, when the dimension reduction is not required by the feature dimension reduction unit, the artificial intelligence clustering unit generates the clustering data by performing the unsupervised learning algorithm using the clustering machine learning library of the HDBSCAN receiving the feature scaling information.
